(19) United States
(12) Patent Application Publication
(10) Pub. No.: US 2026/0352009 A1
(43) Pub. Date: Nov. 5, 2026

(54) SYSTEM FOR CONTROLLING A CHARGE AND/OR DISCHARGE POWER OF AT LEAST ONE ENERGY STORE

(71) Applicant: ENSPIRED GMBH, Wien (AT)

(72) Inventors: Jürgen Mayerhofer, Wien (AT); Wolfgang Eichberger, Wien (AT)

(21) Appl. No.: 19/488,314

(22) PCT Filed: Jun. 5, 2024
(86) PCT No.: PCT/EP2024/065457

§ 371 Date: Nov. 26, 2025

(30) Foreign Application Priority Data
Jun. 5, 2023 (DE) 10 2023 114 680.7

(51) Int. Cl. H02J 7/90; H02J 3/00; H02J 3/28; H02J 7/44; H02J 7/84; H02J 101/24; H02J 101/28; H02J 101/40; H02J 103/35; H02J 103/40; H02J 103/50

(52) U.S. Cl. CPC H02J 7/933; H02J 3/003; H02J 3/004; H02J 3/28; H02J 7/44; H02J 7/84; H02J 2101/24; H02J 2101/28; H02J 2101/40; H02J 2103/35; H02J 2103/40; H02J 2103/50

(57) ABSTRACT

The invention relates to a system (10) for controlling a charge and/or discharge power (PE, PL) of at least one energy store (20) over a predefined operating period (B) for charging the energy store (20) from a grid (30) and/or for feeding energy from the energy store (20) into the grid (30), wherein by means of an energy store control unit (11) a first charge and/or discharge profile (LEP1) over the operating period (B) can be determined which comprises first charge and/or discharge powers (P_{LEP1}), in particular for predefined charge and/or discharge periods (t1 to t8), wherein by means of a grid state control unit (12), depending on a current grid state (30), in particular dependent on a grid frequency, and/or a grid state forecast (31), at least one target power profile (SLP) with at least one target charge and/or discharge power (P_{SLP}) for at least part of the operating period can be determined, wherein by means of a charge and/or discharge power control unit (13) the first charge and/or discharge profile (LEP1) can be changed at least to a second charge and/or discharge profile (LEP2), in particular taking into consideration the target power profile (SLP).

The invention relates to a system for controlling a charge and/or discharge power of at least one energy store.

For controlling the charge and/or discharge power of an energy store, it is desirable to provide a charge and/or discharge profile so that the energy store can be charged and discharged based on it.

The object of the invention is to provide a new and/or improved system for controlling a charge and/or discharge power of at least one energy store.

This object is achieved by means of a system according to claim 1. Advantageous further developments arise in particular from the claims dependent on claim 1.

According to claim 1, the invention relates to a system for controlling a charge and/or discharge power of at least one energy store over a predefined operating period for charging the energy store from a grid and/or for feeding energy from the energy store into the grid, wherein by means of an energy store control unit a first charge and/or discharge profile over the operating period can be determined, which comprises first charge and/or discharge powers, in particular during predefined charge and/or discharge periods,

wherein by means of a grid state control unit, depending on a current grid state, in particular depending on a grid frequency and/or a grid state forecast, at least one target power profile (or: third charge and/or discharge profile) with target charge and/or discharge powers or at least one target charge and/or discharge power (or: with a third charge and/or discharge power) for at least a first part of the operating period or the entire operating period can be determined, in particular during the predefined charge and/or discharge periods,
wherein the first charge and/or discharge profile can be changed at least to a second charge and/or discharge profile by means of a charge and/or discharge power control unit, in particular taking into account the target power profile.

The target charge profile can also be referred to as the third charge and/or discharge profile. The target charge and/or discharge power can also be referred to as the third charge and/or discharge power.

In one embodiment, the first charge and/or discharge profile can be changed at least to the second charge and/or discharge profile by the charge and/or discharge power control unit, in such a way that the first charge and/or discharge powers of the first charge and discharge profile and/or that the at least one target charge and/or discharge power of the target power profile is/are not exceeded for the first part of the operating period or the operating period, in particular during the respective predefined charge and/or discharge periods.

In one embodiment, the first charge and/or discharge profile can be changed at least to the second charge and/or discharge profile by the charge and/or discharge power control unit, in such a way that the first charge and/or discharge powers of the first charge and discharge profile and/or that the target charge and/or discharge powers of the target power profile are not exceeded for the first part of the operating period, in particular during the respective predefined charge and/or discharge periods.

In one embodiment, not exceeding should be understood to mean a value between 0 and the respective charge or discharge power, but not a charge instead of a discharge or a discharge instead of a charge.

In one, in particular further, exemplary embodiment, not exceeding should be understood to mean in particular a power value between a respective charge power and a respective discharge power. This can mean, for example, that, during a predefined charge and/or discharge period, a charge power defined by the first charge and/or discharge profile at a discharge power defined by the target power profile for this charge and/or discharge period is changed or can be changed to the discharge power defined by the target power profile for this charge and/or discharge period, in particular by the charge and/or discharge power control unit.

In one embodiment, in the first part of the operating period or in the operating period, the target charge and/or discharge power is at least intermittently lower than the first charge and/or discharge powers.

In one embodiment, the second charge and/or discharge profile is provided for controlling the charge and/or discharge power of the at least one energy store. In one embodiment, the second charge and/or discharge profile defines the power with which the at least one energy store is charged and/or discharged. For this purpose, in particular a signal is generated and preferably transmitted to the energy store, which determines the charge and/or discharge power of the at least one energy store. Preferably, the charging and/or discharging of the at least one energy store from and/or into the grid takes place according to the second charge and/or discharge profile.

By means of the second charge and/or discharge profile, a charge and/or discharge power of the at least one energy store over the predefined operating period is preferably controlled for charging the energy store from a grid and/or for feeding energy from the energy store into the grid.

The system according to the invention makes it possible in particular to determine and/or provide the second charge and/or discharge profile both on the basis of the first charge and/or discharge profile determined by means of the energy store control unit, and on the basis of the at least one target power profile determined by means of the grid state control unit depending on a current grid state, in particular depending on a grid frequency, and/or on a grid state forecast.

The system according to the invention makes it possible in particular to determine the second charge and/or discharge profile both on the basis of data, in particular movement data, of the energy store and on the basis of at least one current grid state and/or a grid state forecast. This enables in particular, on the one hand, the charging and discharging of the energy store to take place within the permissible and/or desired limits, in particular with a maximum charge and/or discharge power, and on the other hand, that any oversupply and/or undersupply is not further reinforced, but rather can be reduced or eliminated.

The system according to the invention makes it possible, in particular, to determine the second charge and/or discharge profile both with regard to an improved usage of the energy store, and with regard to improvement in the grid stability, in particular with regard to a reduction of grid underloads and grid overloads.

In particular, the target power profile comprises the grid-related requirements for charging and discharging the energy store, whereas the first charge and/or discharge profile comprises the storage-related requirements for charging and discharging the energy store. In particular, the second charge and/or discharge profile takes into account both the grid-related and the storage-related requirements for charging and discharging the energy store.

In particular, the at least one target charge and/or discharge power comprises a (target) charge and/or discharge power determined by the grid state control unit based on a power available in the grid, in particular in the sense of compensating for an oversupply or undersupply in the grid, and/or for balanced grid operation. In one embodiment, a target charge power corresponds to an excess power available in the grid, in particular in the sense of an oversupply to the grid. In one embodiment, a target discharge power corresponds to a power lacking in the grid, in particular in the sense of an undersupply in the grid.

In one embodiment, a target charge and/or discharge power corresponds to a charge and/or discharge power required for a balanced grid operation. The at least one target charge and/or discharge power is, in particular, the charge and/or discharge power required for a balanced operation of the grid, by means of which, in particular, a difference between the power fed into the grid and the power extracted from the grid is compensated.

The target power profile preferably comprises at least one target charge and/or discharge power. A target charge and/or discharge power refers in particular to at least one predefined charge and/or discharge period.

The system according to the invention makes it possible, in particular, to draw energy from the grid at times of oversupply and to feed energy into the grid at times of undersupply.

Preferably, the system allows a reduction of an oversupply and/or undersupply of the grid by at least 1%, in particular for at least one predefined charge and/or discharge period.

Particularly preferably, the system allows, in one embodiment, a compensation of an oversupply and/or undersupply of the grid, in particular for at least one predefined charge and/or discharge period.

Energy is understood in particular to mean electrical energy. Charging of the energy store is understood in particular to mean a current flow from the grid into the energy store. Discharging of the energy store is understood in particular to mean a current flow from the energy store into the grid.

A charge and/or discharge power is understood in particular to mean a power profile over the operating period, which comprises, for predefined charge and/or discharge periods, discharging the energy store into the grid by a discharge power during a respective discharge period and/or charging the energy store from the grid by a charge power during a respective charge period, or neither a charge or discharge.

In one embodiment, the system comprises an updating unit by means of which the first and/or second charge and/or discharge profile and/or the target power profile can be updated in update steps with a predefined frequency, in particular with a frequency in the range from 1 to 10 seconds, so that a rolling process can be generated, wherein the start and end of the operating period, in particular with each update, are shifted backward by the difference relative to the preceding update step.

In particular, the updating unit generates an update signal with the frequency, preferably in the range from 1 to 10 seconds, and forwards this to the energy store control unit and/or the grid state control unit and/or the charge and/or discharge power control unit, which after receiving the update signal, update the first and/or second charge and/or discharge profile and/or the target power profile.

In one embodiment, the duration of an operating period is 1 to 4 days, in particular starting a first time interval, preferably 10 to 20 seconds, after the current time.

In one embodiment, the energy store comprises a store data unit, a charge and/or discharge control unit and/or a storage unit.

In one embodiment, the storage unit comprises at least one accumulator or a plurality of accumulators or contains the same, wherein the accumulator or the plurality of accumulators in particular has a power of at least 500 kw, preferably of at least 2 MW.

In one embodiment, the storage unit comprises at least one battery store or a plurality of battery stores or contains the same, wherein the battery store or the plurality of battery stores has in particular a power of at least 500 kw, preferably of at least 2 MW.

An energy store is in particular a rechargeable energy store and/or a rechargeable galvanic element. A battery store is in particular a rechargeable battery store and/or rechargeable galvanic element.

The battery store may comprise, for example, at least one LiFePO4 storage unit and/or at least one lithium-ion storage unit. The battery store may comprise at least one sodium-ion accumulator and/or sodium-ion storage unit (Sodium-Ion Battery, SIB).

The battery store may comprise, for example, at least one flow battery store, in particular redox-flow battery store, liquid battery and/or wet cell. The flow battery store is in particular an accumulator. The flow battery store stores electrical energy in particular in chemical compounds, wherein the reaction agents are in the form of a solvent in dissolved form.

The battery store may comprise at least one thermal store. In particular, the thermal store can be electrically charged.

A battery store comprises or is in particular a solar battery, solar accumulator or domestic energy store. A battery store comprises or is in particular a stationary or mobile energy store. A battery store comprises or is in particular a rechargeable energy store and/or an energy store based on an accumulator.

In one embodiment, the energy store comprises a power, in particular an electrical input and/or output power, between 3 MW and 600 MW. In one embodiment, the energy store comprises a, in particular electrical, capacity between 3 MWh and 1200 MWh.

In one embodiment, the energy store comprises a grid-scale battery store.

In one embodiment, the energy store comprises a co-located battery store, in particular in cooperation with a photovoltaic system and/or having a power between 2 and 5 MW.

In one embodiment, the energy store comprises a behind-the-meter battery store, in particular having a power between 6 kW and 600 kW.

In one embodiment, the energy store comprises an EV battery store and/or a storage unit in cooperation with a photovoltaic system and a wind turbine and/or a storage unit in cooperation with a combined heat and power plant and/or run-off-river.

In one embodiment, the energy store control unit comprises an energy management system, EMS, a battery management system, BMS, a power management system, PMS, and/or a frequency controller, wherein in particular the energy store control unit collects store data from a store data unit of the energy store.

In one embodiment, the energy store control unit collects data, in particular first data, preferably movement data of the energy store, in particular the current state of charge, Soc, the current state of health, SoH, the current capacity, data, in particular temperatures, voltages and/or resistances, of cells of the energy store and/or the current temperature of the energy store, in particular within its container, and/or of the environment of the energy store.

The energy store control unit determines a first charge and/or discharge profile over the operating period, which comprises first charge and/or discharge powers, in particular during predefined charge and/or discharge periods. For this purpose, from the data of the energy store the energy store control unit preferably determines charge powers and subsequent discharge powers, which, for example, enable the fastest possible charging and later discharging of the energy store, but without excessively overloading the energy store, for example by excessive temperatures and/or excessive voltages and/or currents.

For example, the energy store control unit can calculate a first charge power from a maximum permissible charge current and an operating voltage.

The energy store is or preferably comprises a, in particular rechargeable, battery or an accumulator. The energy store preferably comprises cells, in particular storage cells or battery cells.

The system according to the invention makes it possible, in particular, to determine the second charge and/or discharge profile both with regard to an improved usage and/or extended service life of the energy store, and with regard to improvement in the grid stability, in particular with regard to a reduction of grid underloads and grid overloads.

The system according to the invention allows in particular, for at least the same or even greater usage of the energy store for grid stability, the service life of the energy store to be extended, preferably by means of a degradation-based optimization of the energy store by the system. The system according to the invention allows in particular a reduction in the degradation of the energy store, preferably by at least 5%, particularly preferably by at least 10% or 20%, for the same or greater usage of the energy store for grid stability.

In particular, a degradation of the energy store refers to a process by which the amount of energy that the energy store can store, or the amount of power that the energy store can provide, is permanently reduced.

In one embodiment, the energy store control unit determines or estimates data, in particular second data, preferably movement data, of the energy store. The data, in particular second data, are in particular stress factors of the energy store. The data, in particular second data, preferably comprise at least one, any combination, or all of the following data:
Stress due to ageing of the energy store (“Time stress”)
Stress due to temperature of the energy store unit (“Temperature stress”)
Stress due to the state of charge of the energy store (“State of charge stress”)
Stress due to charge and/or discharge current of the energy store (“C-rate stress”)
Stress due to the amplitude of the state of charge curve of the energy store (“Depth of discharge stress”)
Stress caused by the formation of the solid electrolyte interphase in the energy store (“Solid electrolyte interphase film formation”)
Stress from chemically induced transitions in the voltage profile of the energy store

Stress due to ageing of the energy store (“Time stress”) preferably refers to the decrease in capacity and efficiency of the energy store due to ageing, in particular irrespective of the use of the energy store.

Stress due to temperature of the energy store (“temperature stress”) preferably refers to the decrease in capacity and efficiency of the energy store due to unfavourable temperatures of cells of the energy store, in particular due to temperatures above a maximum temperature and/or due to temperatures below a minimum temperature. In particular, both too low and too high temperatures can lead to stress, with different effects on the cells of the energy store, in particular a reduction in the service life of the cells of the energy store and/or an increase in the internal resistance of the cells of the energy store. The temperature of the cells and/or the stress caused by temperature can be dependent in particular on the charge and/or discharge current f the energy store or show dependencies on the charge and/or discharge current of the energy store.

The dependence between temperature and stress due to temperature is preferably non-linear.

Stress due to the state of charge of the energy store (“State of charge stress”) preferably refers to stress that is caused by the retention of energy in the energy store at certain, in particular high, charge levels of the energy store. The dependence between the state of charge of the energy store and stress caused by the state of charge is preferably non-Stress linear.

Stress caused by the charge or discharge current of the energy store (“C-rate stress”) is caused in particular by high or higher charge and discharge currents of the energy store.

The dependence between the current strength of the charge or discharge current and stress caused by the charge or discharge current is preferably non-linear.

Stress due to the amplitude of the state of charge curve or charge curve of the energy store (“Depth of discharge stress”) is caused in particular by charge cycles with a higher amplitude between the charged and discharged state of the energy store, in particular by an amplitude level between the charged and discharged state of the energy store which is greater than a predefined amplitude.

The dependence between amplitude or amplitude level and stress due to amplitude of the state of charge curve is preferably non-linear.

Stress due to solid-electrolyte interphase film formation in the energy store refers in particular to stress caused by a process that is particularly pronounced in the case of new energy stores (or: batteries) and is accelerated by the other stressors or stress factors. The process is preferably non-linear.

Stress from chemically induced transitions in the voltage profile of the energy store refers in particular to stress which concentrates on chemical processes at certain transitions of the state of charge, which lead to increased stress. Certain transitions of the charge state are preferably selective effects on the voltage curve of the energy store. In particular, the stress from chemically induced transitions in the voltage curve depends nonlinearly, preferably highly nonlinearly, on the voltage and/or the voltage curve of the energy store.

Preferably, the second data are determined or estimated from the first data.

The energy store control unit determines the first charge and/or discharge profile in particular from or using the data determined, estimated and/or collected by the energy store control unit, in particular from the first and/or second data.

In one embodiment, the energy store control unit is designed to determine the first charge and/or discharge profile from or by using the, in particular first and/or second, data of the energy store determined, estimated and/or collected by the energy store control unit.

In one embodiment, the energy store control unit collects data, in particular determines or estimates first or the first data, of the energy store or from the energy store, in particular second or the second data of the energy store, preferably from or using the first data, and determines or estimates the first charge and/or discharge profile from the data, in particular the first and/or second data.

The term “stress” is preferably understood in each case to mean an excessive loading of the energy store and/or a loading which reduces the service life of the energy store, in particular compared to a predefined service life. Processes in or on the energy store that cause excessive demand, or stress, are also referred to in particular as stress factors.

In one embodiment, the grid state control unit detects and/or determines grid signals of the grid, in particular a current grid frequency and/or a forecast of the grid frequency, a grid state, in particular an over-or undersupply, preferably at one second intervals, preferably every 1 to 10 seconds.

In one embodiment, the grid state control unit comprises at least one frequency measuring unit for determining a current grid frequency.

In one embodiment, the grid state control unit detects and/or determines a grid state forecast.

In particular, a grid state forecast comprises a forecast of the feed-in energy into the grid, a forecast of the energy extracted from the grid and a forecast of oversupply and/or undersupply in the grid based thereon.

A grid state forecast comprises in particular a photovoltaic forecast and/or a wind forecast, preferably on the basis of at least one weather model.

A photovoltaic forecast and/or a wind forecast is understood to mean, in particular, a forecast of the expected influence of the power fed into the grid by photovoltaic systems and/or wind turbines. In particular, on the basis of at least one weather model and/or on the basis of weather forecast data, a prospective solar irradiation and/or a prospective, in particular average, wind strength is determined, preferably in relation to a grid area assigned to the grid.

Preferably, on the basis of the prospective solar irradiation and/or the prospective, in particular average, wind strength, a prospective feed-in energy into the grid is determined.

The grid state forecast comprises in particular consumption forecasts and/or forecasts of the control power demand.

A consumption forecast is understood to mean, in particular, a forecast of the expected influence of the electricity consumption in the grid. A consumption forecast is understood to mean, in particular, a forecast of the expected extraction of power from the grid.

The grid state forecast comprises in particular weather models and/or satellite images and/or a Saharan dust forecast.

The grid state forecast comprises in particular the availability of systems feeding power into the grid, e.g. at least one coal-fired unit.

The grid state forecast includes in particular the evaluation of thermal images of power plants by infrared cameras and/or magnetic resonance measurements on power plants by power lines.

The grid state forecast may, in one embodiment, include price forecasts as well as a forecast of the power levels available, requested and/or offered.

Preferably, the forecast of the energy fed into the grid comprises a forecast of at least one feed-in type. Feed-in types include, for example, a photovoltaic feed-in, a feed-in due to wind energy and/or a feed-in due to power plants.

In one embodiment, the grid is a power grid, in particular a public power grid and/or external power grid and/or local power grid and/or internal power grid.

In one embodiment, the power grid is or comprises a high-voltage grid. In particular, the grid is operated with a voltage between 100 kV and 380 kV.

In one embodiment, the charge and/or discharge periods are predefined at one second intervals or at intervals of 5 to 60 minutes, in particular as positive and/or negative values or as charge and/or discharge profiles.

In particular, the operating period consists of a plurality of charge and/or discharge periods. Preferably, the duration of each charge and/or discharge period is between 5 and 60 minutes.

In one embodiment, the first charge and/or discharge profile comprises at least one discharge from the energy store into the grid and at least one subsequent charge of the energy store from the grid, in particular in such a way that the charge of the energy store exceeds at least a first charge state of the energy store and the subsequent discharge of the energy store falls below at least a second charge state of the energy store.

The first charge and/or discharge profile refers in particular to at least one discharge from the energy store into the grid and at least one subsequent charge of the energy store from the grid, taking into account the data or movement data of the energy store.

A state of charge is, in particular, the state of charge of the energy store in relation to its storage capacity. The state of charge is preferably expressed as a percentage. Preferably, a state of charge of 0% denotes an empty energy store and/or a state of charge of 100% a full energy store. The charge state is preferably referred to as “State of charge”, SoC.

In one embodiment, the first state of charge is at least 80%, in particular at least 90%. In one embodiment, the second state of charge is a maximum of 20%, in particular a maximum of 10%.

In one embodiment, the first state of charge is such that it differs from the second state of charge by at least a predefined discharge depth, Depth of Discharge, DoD. Preferably, the predefined discharge depth is at least 60%, further preferably at least 70%, further preferably at least 80%, in particular at least 90%.

Preferably, the first charge and/or discharge profile causes a cyclic charging and discharging of the energy store.

In one embodiment, the first charge and/or discharge profile comprises the respective maximum charge and/or discharge power determined from the battery data.

A charge power is understood to mean in particular the charging of the energy store from the grid with an electrical power. The charge power is derived in particular from a charge current that is multiplied by a charge voltage.

The discharge power is understood to mean in particular the discharging of the energy store into the grid with an electrical power. The discharge power is derived in particular from a discharge current that is multiplied by a discharge voltage.

In one embodiment, the target power profile comprises at least one target infeed from the energy store into the grid and/or at least one target charge of the energy store from the grid according to an expected grid deviation.

In one embodiment, the target power profile comprises the maximum extraction and/or infeed power from the grid or into the grid, determined in each case depending on a current grid state, in particular depending on a grid frequency, and/or a grid state forecast.

In one embodiment, the target power profile comprises a charge or discharge power for the respective charge and/or discharge period forecast by means of the grid state forecast, in particular by the grid state control unit.

In one embodiment, the target power profile takes into account at least one predicted grid state further in the future, for example on the following day, for defining a charge and/or discharge period. For example, the target power profile may take into account the fact that an over-or undersupply at a future time, for example on a following day, is predicted to be even greater than in a charge and/or discharge period, so that a corresponding target charge or discharge power in the charge and/or discharge period is reduced.

In one embodiment, the charge and/or discharge power control unit provides the second charge and/or discharge profile to at least one charge and/or discharge control unit of the energy store for controlling the charge and/or discharge power.

In one embodiment, the system, in particular the energy store control unit and/or the grid state control unit and/or the charge and/or discharge power control unit, comprises a, in particular artificial and/or machine-based, neural network and/or a network based on artificial intelligence (AI system, AI unit).

In one embodiment, the neural network is formed in particular by a feed-forward network. In particular, the feed-forward network is designed in such a way that the outputs of the neurons are directed only in the processing direction and/or are not fed back by a recurrent edge.

The neural network comprises in particular at least one input layer, at least one output layer, and at least one, preferably at least two, hidden layers.

In one embodiment, the system, in particular the energy store control unit and/or the grid state control unit and/or the charge and/or discharge power control unit, implements a reinforcement learning or reinforcement machine learning (RL). In particular, in such a case a software agent autonomously learns a strategy for maximizing the rewards obtained.

In one embodiment, the system, in particular the energy store control unit and/or the grid state control unit and/or the charge and/or discharge power control unit, comprises at least one unit based on machine learning.

The invention also relates to an arrangement of a system for controlling a charge and/or discharge power of at least one energy store over a predefined operating period for charging the energy store from a grid and/or for feeding energy from the energy store into the grid, and an energy store and/or a grid.

The system according to the invention is further described in the following in the exemplary embodiments with reference to figures. In the drawing

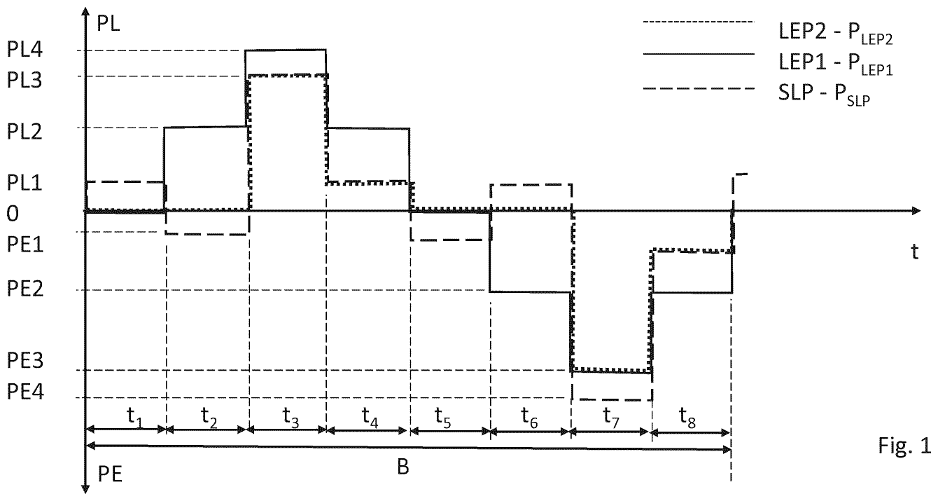

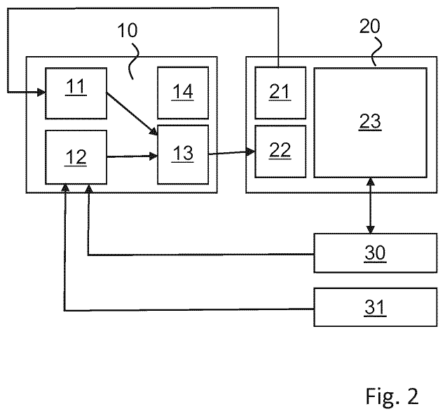

FIG. 1 shows charge profiles according to the invention and FIG. 2 shows a system according to the invention.

FIG. 2 shows a system 10 for controlling a charge power PL and/or discharge power PE according to FIG. 1, of at least one energy store 20 over a predefined operating period B for charging the energy store 20 from a grid 30 and/or for feeding energy from the energy store 20 into the grid 30.

By means of an energy store control unit 11 a first charge and/or discharge profile LEP1 according to FIG. 1 over the operating period B can be determined, which comprises first charge and/or discharge powers P_{LEP1} at predefined charge and/or discharge periods t₁ to t₉.

By means of a grid state control unit 12, depending on a current grid state 30, in particular depending on a grid frequency and/or on a grid state forecast 31, at least one target power profile SLP with at least one target charge and/or discharge power PSLP for at least a first part of the operating period B can be determined.

By means of a charge and/or discharge power control unit 13, the first charge and/or discharge profile LEP1 can be changed at least to a second charge and/or discharge profile LEP2, in such a way that the first charge and discharge powers P_{LEP1} of the first charge and discharge profile LEP1 for the operating period are not exceeded and that the target charge and discharge powers P_{SLP} of the target power profile SLP for the operating period are not exceeded.

In the first part of the operating period, the charge and/or discharge power P_{SLP} is in each case lower than the first charge and/or discharge powers P_{LEP1}. The second charge and/or discharge profile LEP2 is provided for controlling the charge and/or discharge power of the at least one energy store 30.

The first charge and/or discharge profile, the second charge and/or discharge profile and the target power profile can be updated by an updating unit 14 in update steps with a predetermined frequency, in particular with a frequency in the range from 1 to 10 seconds.

This enables a rolling process to be generated, wherein the start and end of the operating period B are shifted backward, in particular with each update, by the difference relative to the preceding update step.

The duration of an operating period B is 1 to 4 days, in particular starting a first time interval, preferably 10 to 20 seconds, after the current time.

The energy store 20 comprises a store data unit 21, a charge and/or discharge control unit 22 and a storage unit 23.

The storage unit 23 has at least one battery store or a plurality of battery stores, wherein the battery store or the plurality of battery stores in particular has a power of at least 500 kW, preferably of at least 2 MW.

The energy store 20 may comprise a grid-scale battery store, in particular with a power between 3 MW and 22 MW.

Alternatively or additionally, the energy store 20 can comprise a co-located battery store, in particular in cooperation with a photovoltaic system and/or having a power between 2 and 5 MW.

Alternatively or additionally, the energy store 20 may comprise a behind-the-meter battery store, in particular with a power between 6 kW and 600 kw.

Alternatively or in addition, the energy store 20 may comprise an EV battery store and/or a storage unit in cooperation with a photovoltaic system and a wind turbine and/or a storage unit in cooperation with a combined heat and power plant and/or run-off-river.

The energy store control unit 11 comprises an energy management system, EMS, battery management system, BMS, power management system, PMS, and/or a frequency controller.

In particular, the energy store control unit 11 collects store data from a store data unit 21 of the energy store 20.

The energy store control unit 11 collects data, in particular first data and/or movement data, of the energy store 20.

In particular, the data, in particular first data, could comprise the current state of charge, SoC, the current state of health, SoH, the current capacity, data, in particular temperatures, voltages and/or resistances, of cells of the energy store and/or the current temperature of the energy store, in particular within its container, and/or of the environment of the energy store.

In particular, the system is designed to extend the service life of the energy store 20 in the case of at least equal usage of the energy store 20 for grid stability, preferably by means of a degradation-based optimization of the energy store 20. Preferably, the system causes a reduction in the degradation of the energy store 20, preferably by at least 5%, in the case of at least equal or approximately equal usage of the energy store for grid stability.

In particular, the energy store control unit 11 determines or estimates data, in particular second data, or movement data of the energy store 20, wherein the data, in particular second data, comprise at least one, any combination or all of the following data:
Stress due to ageing of the energy store (“Time stress”),
Stress due to temperature of the energy store unit (“Temperature stress”),
Stress due to the state of charge of the energy store (“State of charge stress”),
Stress caused by charge or discharge current of the energy store (“C-rate stress”),
Stress due to the amplitude of the state of charge curve of the energy store (“Depth of discharge stress”),
Stress caused by the formation of the solid electrolyte interphase in the energy store (“Solid electrolyte interphase film formation”),
Stress from chemically induced transitions in the voltage profile of the energy store.

Preferably, the second data are determined or estimated from the first data.

The energy store control unit determines the first charge and/or discharge profile LEP1 in particular from or by using the first and/or second, data of the energy store determined, estimated and/or collected by the energy store control unit 11.

The grid state control unit 12 detects grid signals of the grid 30, in particular a current grid frequency and/or a forecast 31 of the grid frequency, a grid state, in particular an over-or undersupply, preferably at one second intervals, preferably every 1 to 10 seconds.

The grid 30 is a power grid, in particular a public power grid. Alternatively or in addition, the grid may be an external power grid and/or local power grid and/or internal power grid.

The charge and/or discharge periods are predefined at one second intervals or at intervals of 5 to 60 minutes, in particular as positive and/or negative values or as charge and/or discharge profiles.

The first charge and/or discharge profile LEP1 comprises at least one discharge from the energy store 20 into the grid and at least one subsequent charge of the energy store 20 from the grid.

The charging of the energy store 20 is carried out in particular in such a way that the charge of the energy store 20 exceeds at least a first, predefined, state of charge of the energy store 20.

The subsequent discharge of the energy store 20 is carried out in particular in such a way that the discharge of the energy store 20 falls below at least a second, predefined, state of charge of the energy store 20.

The target power profile SLP comprises at least one target infeed from the energy store 20 into the grid and at least one target charge of the energy store 20 from the grid according to an expected grid deviation.

In one embodiment, the target power profile SLP comprises a charge or discharge power for the respective charge and/or discharge period forecast by means of the grid state forecast, in particular by the grid state control unit 12.

In one embodiment, the target power profile SLP takes into account at least one predicted grid state further in the future, for example on the following day, for defining a charge and/or discharge period. For example, the target power profile may take into account the fact that an over- or undersupply at a future time, for example on a following day, is predicted to be even greater than in a charge and/or discharge period, so that a corresponding target charge or discharge power P_{SLP} in the charge and/or discharge period t₁ to t₈ is reduced.

The charge and/or discharge power control unit 13 provides the second charge and discharge profile LEP2 to at least one charge and/or discharge control unit 22 of the energy store 20 for controlling the charge and/or discharge power.

FIG. 1 shows a schematic view of an exemplary first charge and discharge profile LEP1 as a solid line with first charge and discharge powers P_{LEP1}, a second charge and discharge profile LEP2 as a dashed line with second charge and discharge powers P_{LEP2}, and a target power profile SLP as a (substantially) dotted line with target charge and discharge powers P_{SLP}. For ease of interpretation, lines superimposed on each other are drawn slightly offset from each other in FIG. 1.

In FIG. 1, charge powers PL are shown toward the top; discharge powers PE are shown toward the bottom. Depending on whether the power is in the upper or lower range, charging or discharging of the energy store is specified.

In the exemplary embodiment according to FIG. 1, not exceeding should be understood to mean a value between 0 and the respective charge or discharge power, but not a charge instead of a discharge or a discharge instead of a charge.

In one, in particular further exemplary embodiment not illustrated, not exceeding is to be understood, in particular, to mean a power value between a respective charge power and a respective discharge power. This can mean, for example, that during a predefined charge and/or discharge period, corresponding to t₁ to t₈, a charge power defined by the first charge and/or discharge profile at a discharge power defined by the target power profile for this charge and/or discharge period is changed or can be changed to the discharge power defined by the target power profile for this charge and/or discharge period, in particular by the charge and/or discharge power control unit.

The profiles are shown over an operating period B, which in the exemplary embodiment according to FIG. 1 is divided into a timescale of eight periods t₁ to t₈, each extending over 5 to 60 minutes.

In the period T₁ according to FIG. 1, the first charge and discharge power P_{LEP1} of the first charge and discharge profile LEP1 is now at zero, whereas the target charge power P_{SLP} of the target power profile SLP is at a value PL1.

The charge and discharge power control unit 13 now changes the first charge and discharge profile LEP1 in the period t₁ into the second charge and discharge profile LEP2, in such a way that the first charge and discharge power P_{LEP1} of the first charge and discharge profile LEP1 for the period t₁ of the operating period is not exceeded and that the target charge power PL1 of the target power profile SLP for the period t₁ of the operating period is not exceeded.

This results in a second charge and discharge power P_{LEP2} of the second charge and discharge profile LEP2 of zero in the period t₁. Thus, the energy store is neither charged nor discharged, since neither a charge power nor a discharge power greater than zero is present.

In the period t₂, the first charge power P_{LEP1} of the first charge and discharge profile LEP1 is at PL2, whereas the target discharge power P_{SLP} of the target power profile SLP is at a value PE1.

The charge and discharge power control unit 13 changes the first charge and discharge profile LEP1 in the period t₂ into the second charge and discharge profile LEP2, in such a way that the first charge power PL2 of the first charge and discharge profile LEP1 for the period t₂ of the operating period is not exceeded and that the target discharge power PE1 of the target power profile SLP for the period t₂ of the operating period is not exceeded.

This results in a second charge and discharge power P_{LEP2} Of the second charge and discharge profile LEP2 of zero in the period t₂. Thus, the energy store is neither charged nor discharged, since neither a charge power nor a discharge power greater than zero is present.

In the present case, the first charge and discharge profile LEP1 in the period to comprises a first charge power PL2, whereas the target power profile SLP has a target discharge power PE1.

Since not exceeded is considered to be a value between 0 and PL2 or 0 and PE1 respectively, the second charge and discharge power P_{LEP2} in the period t₂ is zero.

In the period t₃, the first charge power P_{LEP1} of the first charge and discharge profile LEP1 is at PL4, whereas the target discharge power P_{SLP} of the target power profile SLP is at a value PL3.

The charge and discharge power control unit 13 changes the first charge and discharge profile LEP1 in the period t₃ into the second charge and discharge profile LEP2, in such a way that the first charge power PL4 of the first charge and discharge profile LEP1 for the period t₃ of the operating period is not exceeded and that the target charge power PL3 of the target power profile SLP for the period t₃ of the operating period is not exceeded.

This results in a second charge power P_{LEP2} of the second charge and discharge profile LEP2 of PL3 in the period t₃. This means that the energy store is charged because a charge power PL3 greater than zero is present.

In the period to of the operating period B, the target power PL3 is therefore lower than the first charge power PL4.

In the period t₇, the first discharge power P_{LEP1} of the first charge and discharge profile LEP1 is at PE3, whereas the target discharge power P_{SLP} of the target power profile SLP is at a value PE4.

The charge and discharge power control unit 13 changes the first charge and discharge profile LEP1 in the period t₇ into the second charge and discharge profile LEP2, in such a way that the first discharge power PE3 of the first charge and discharge profile LEP1 for the period t₇ of the operating period is not exceeded and that the target discharge power PE4 of the target power profile SLP for the period t₇ of the operating period is not exceeded.

This results in a second discharge power P_{LEP2} of the second charge and discharge profile LEP2 of PE3 in the period t₇. This means that the energy store is discharged because a discharge power PE3 greater than zero is present.

The grid state forecast comprises in particular a photovoltaic forecast and/or a wind forecast, preferably on the basis of at least one weather model. A photovoltaic forecast and/or a wind forecast is understood to mean, in particular, a forecast of the expected influence of the power fed into the grid by photovoltaic systems and/or wind turbines.

The grid state forecast comprises in particular consumption forecasts and/or forecasts of the control power demand. A consumption forecast is understood to mean, in particular, a forecast of the expected influence of the electricity consumption in the grid.

The grid state forecast comprises in particular weather models and/or satellite images and/or a Saharan dust forecast.

The grid state forecast comprises in particular the availability of systems feeding power into the grid, e.g. a coal-fired unit.

The grid state forecast includes in particular the evaluation of thermal images of power plants by infrared cameras and/or magnetic resonance measurements on power plants by power lines.

The grid state forecast may, in one embodiment, include price forecasts as well as a forecast of the power levels available, requested and/or offered.

### LIST OF REFERENCE SIGNS

10 system
11 energy store control unit
12 grid state control unit
13 charge and/or discharge power control unit
14 updating unit
20 energy store
21 store data unit
22 charge and/or discharge control unit
23 storage unit
30 grid
31 forecast
B operating period
t₁ . . . t₈ to charge and/or discharge periods
LEP1 first charge and/or discharge profile
LEP2 second charge and/or discharge profile
SLP target power profile
PL charge power
PE discharge power
PL1 . . . 4 charge powers
PE1 . . . 4 discharge powers
P_{LEP1} first charge and/or discharge powers
P_{LEP2} second charge and/or discharge powers
P_{SLP} target charge and/or discharge power

1. System (10) for controlling a charge and/or discharge power (PE, PL) of at least one energy store (20) over a predefined operating period (B) for charging the energy store (20) from a grid (30) and/or for feeding energy from the energy store (20) into the grid (30),
wherein by means of an energy store control unit (11) a first charge and/or discharge profile (LEP1) over the operating period (B) can be determined, which comprises first charge and/or discharge powers (P_{LEP1}), in particular at predefined charge and/or discharge periods (t₁ to t₈),
wherein, by means of a grid state control unit (12), depending on a current grid state (30), in particular depending on a grid frequency, and/or a grid state forecast (31), at least one target power profile (SLP) with at least one target charge and/or discharge power (P_{SLP}) for at least a first part of the operating period can be determined,
wherein the first charge and/or discharge profile (LEP1) can be changed at least to a second charge and/or discharge profile (LEP2) by means of a charge and/or discharge power control unit (13), in particular taking into account the target power profile (SLP).

2. System according to claim 1, wherein the first charge and/or discharge profile (LEP1) can be changed at least to the second charge and/or discharge profile (LEP2) by the charge and/or discharge power control unit (13), in such a way that the first charge and/or discharge powers (P_{LEP1}) of the first charge and discharge profile (LEP1) and/or that the at least one target charge and/or discharge power (P_{SLP}) of the target power profile (SLP) is/are not exceeded for the at least first part of the operating period (B), in particular during the respective predefined charge and/or discharge periods, and/or wherein, in the first part of the operating period, the target charge and/or discharge power (P_{SLP}) is at least intermittently lower than the initial charge and/or discharge powers (P_{LEP1}), and/or
wherein the second charge and/or discharge profile (LEP2) is provided for controlling the charge and/or discharge power of the at least one energy store (30).

3. System according to claim 1, wherein the first and/or the second charge and/or discharge profile can be updated by an updating unit (14) in update steps with a predefined frequency, in particular with a frequency in the range from 1 to 10 seconds, so that a rolling process can be generated, wherein the start and end of the operating period are shifted backward, in particular with each update, by the difference relative to the preceding update step.

4. System according to claim 1, wherein the duration of an operating period is 1 to 4 days, in particular starting a first time interval, preferably 10 to 20 seconds, after the current time.

5. System according to claim 1, wherein the energy store (20) comprises a store data unit (21), a charge and/or discharge control unit (22) and/or a storage unit (23),
wherein the storage unit (23) has at least one battery store or a plurality of battery stores, wherein the battery store or the plurality of battery stores has in particular a power of at least 500 kW, preferably of at least 2 MW.

6. System according to claim 1, wherein the energy store (20) comprises a grid-scale battery store, in particular having a power of between 3 MW and 22 MW, a co-located battery store, in particular in cooperation with a photovoltaic system and/or having a power of between 2 and 5 MW, a behind-the-meter battery store, in particular having a power of between 6 kW and 600 kW, and/or an EV battery store and/or a storage unit in cooperation with a photovoltaic system and a wind turbine, and/or a storage unit in cooperation with a combined heat and power plant and/or run-off-river.

7. System according to claim 1, wherein the energy store control unit (11) comprises an energy management system, EMS, a battery management system, BMS, a power management system, PMS, and/or a frequency controller, wherein in particular the energy store control unit (11) collects store data from a store data unit (21) of the energy store (20).

8. System according to claim 1, wherein the energy store control unit (11) collects data, in particular first data, or movement data of the energy store (20), in particular the current state of charge, SoC, the current state of health, SoH, the current capacity, data, in particular temperatures, voltages and/or resistances, of cells of the energy store and/or the current temperature of the energy store, in particular within its container, and/or of the environment of the energy store.

9. System according to claim 1,
wherein the system is designed to extend the service life of the energy store (20) at the same or greater usage of the energy store (20) for grid stability, preferably by means of a degradation-based optimization of the energy store (20), and/or
wherein the system causes a reduction in the degradation of the energy store (20), preferably by at least 5%, during at least equal or approximately equal usage of the energy store (20) for grid stability.

10. System according to claim 1, wherein the energy store control unit (11) determines or estimates data, in particular second data and/or movement data, of the energy store (20) or is provided for determining or estimating the data, wherein the data, in particular second data, comprise at least one, any combination or all of the following data:
Stress due to ageing of the energy store,
Stress due to the temperature of the energy store,
Stress due to the state of charge of the energy store,
Stress due to charge and/or discharge current of the energy store,
Stress due to amplitude of the charge state curve of the energy store,
Stress due to formation of the solid-electrolyte interphase in the energy store,
Stress from chemically induced transitions in the voltage profile of the energy store.

11. System according to claim 1,
wherein the energy store control unit (11) determines the first charge and/or discharge profile (LEP1) from or by using the, in particular first and/or second, data of the energy store determined, estimated and/or collected by the energy store control unit (11), and/or
wherein the energy store control unit (11) is designed to determine the first charge and/or discharge profile (LEP1) from or by using the, in particular first and/or second, data of the energy store determined, estimated and/or collected by the energy store control unit (11), and/or
wherein the second data are determined or estimated from the first data.

12. System according to claim 1, wherein the grid state control unit (12) detects grid signals of the grid (30), in particular a current grid frequency and/or a forecast (31) of the grid frequency, a grid state, in particular an over-or undersupply, preferably at one second intervals, preferably every 1to 10 seconds.

13. System according to claim 1, wherein the grid state forecast is based on at least one or more of the following: PV forecast, wind forecast, in particular from at least one weather model, consumption forecast of the energy consumption, weather models, satellite images, plant availability (e.g. coal-fired unit), Saharan dust forecast, evaluation of thermal images at power plants by infrared cameras, magnetic resonance measurements at power plants by power lines, energy price forecasts, control power consumption forecast, power levels available, in particular demanded and offered.

14. System according to claim 1, wherein the grid (30) is a power grid, in particular a public power grid and/or external power grid and/or local power grid and/or internal power grid.

15. System according to claim 1, wherein the charge and/or discharge periods are predefined at one second intervals or at intervals of 5 to 60 minutes, in particular as positive and/or negative values or as charge and/or discharge profiles.

16. System according to claim 1, wherein the first charge and/or discharge profile (LEP1) comprises at least one discharge from the energy store (20) into the grid and at least one subsequent charge of the energy store (20) from the grid, in particular in such a way that the charge of the energy store exceeds at least a first charge state of the energy store and the subsequent discharge of the energy store falls below at least a second charge state of the energy store.

17. System according to claim 1, wherein the target power profile (SLP) comprises at least one target infeed from the energy store (20) into the grid and/or at least one target charge of the energy store (20) from the grid according to an expected grid deviation.

18. System according to claim 1, wherein the charge and/or discharge power control unit (13) provides the second charge and/or discharge profile (LEP2) to at least one charge and/or discharge control unit (22) of the energy store (20) for controlling the charge and/or discharge power.

19. System according to claim 1, wherein the system, in particular the energy store control unit and/or the grid state control unit and/or the charge and/or discharge power control unit comprises a, in particular artificial and/or machine-based, neural network and/or a network based on artificial intelligence, wherein the neural network is formed in particular by a feed-forward network, preferably of such a type that the outputs from its neurons are directed only in the processing direction and/or not fed back by a recurrent edge, and/or wherein the system, in particular the energy store control unit and/or the grid state control unit and/or the charge and/or discharge power control unit, implements a reinforcement learning or reinforcement machine learning, RL.
